(19) United States
(12) Patent Application Publication
(10) Pub. No.: US 2005/0055819 A1
(43) Pub. Date: Mar. 17, 2005

(54) Method and apparatus for fastening earrings

(76) Inventor: Nancy Kathryn Tedeschi, Rexford, NY (US)

Correspondence Address: GOODMAN PATENTING, INC., 1187 HILLSIDE AVE, APT. 3B28, NISKAYUNA, NY, 12309, US

(21) Appl. No.: 10/664,253

(22) Filed: Sep. 17, 2003

(51) Int. Cl. B23P 19/04; B21D 39/00

(52) U.S. Cl. 29/456; 29/525.01; 29/240

(57) ABSTRACT

An apparatus for fastening an earring, said apparatus comprising: a motor adapted for generating a torque; and an earring back holder adapted for applying said torque to an earring back.

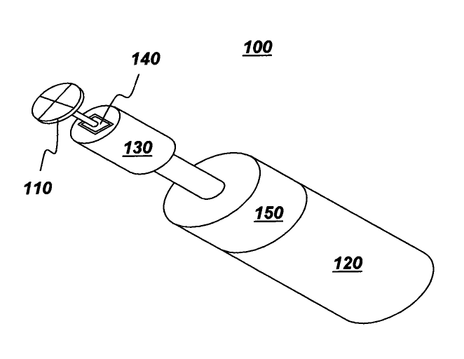

### BACKGROUND

The present invention relates generally to the field of apparel apparatus and more specifically to devices to aid in fastening earrings.

To minimize the chance of accidental loss, especially in more expensive varieties, some earrings for pierced ears feature a threaded post and utilize a threaded earring back to secure the earring in place. The post is passed through the wearer's ear and the earring back is manually screwed onto the post until contact is made with the wearer's skin.

For wearers with ordinary dexterity, manipulating the earring back is at times a frustrating and time consuming operation. For wearers with impaired dexterity, due to, for example, arthritis, or other joint or muscle dysfunction, or simply due to the length of the wearer's fingernails, this manipulation can be close to impossible.

Opportunities exist, therefore, to save time and relieve frustration by providing a device to aid in the fastening of such earrings.

### SUMMARY

The opportunities described above are addressed, in one embodiment of the present invention, by an apparatus for fastening an earring, the apparatus comprising: a motor adapted for generating a torque; and an earring back holder adapted for applying the torque to an earring back.

The opportunities described above are also addressed, in a method embodiment of the present invention, by a method for fastening an earring, the method comprising: generating a torque using a motor; and applying the torque to an earring back using an earring back holder.

### DRAWINGS

These and other features, aspects, and advantages of the present invention will become better understood when the following detailed description is read with reference to the accompanying drawings in which like characters represent like parts throughout the drawings, wherein:

The FIGURE illustrates an isometric drawing in accordance with one embodiment of the present invention.

### DETAILED DESCRIPTION

In accordance with one embodiment of the present invention, the FIGURE illustrates an isometric drawing of an apparatus 100 for fastening an earring 110. Apparatus 100 comprises a motor 120 and an earring back holder 130. In operation, motor 120 generates a torque and earring back holder 130 applies that torque to an earring back 140. Motor 120 refers to any electrical or mechanical apparatus, device, or combination thereof capable of generating a torque including, by way of example, but not limitation, electric motors and spring driven motors. Earring back holder 130 refers to any mechanical device shaped or otherwise adapted to transmit motor torque to earring back 140.

In a more detailed embodiment in accordance with the embodiment of the FIGURE, earring back holder 130 is removable. In some embodiments, different shapes of earring back 140 are accommodated by having different interchangeable (removable) versions of earring back holder 130 with end recesses or other coupling means compatible with the respective different shapes.

In another more detailed embodiment in accordance with the embodiment of the FIGURE, earring back holder 130 is magnetized. Magnetizing earring back holder 130 facilitates holding and applying torque to earring back 140.

In another more detailed embodiment in accordance with the embodiment of the FIGURE, motor 120 is electrically operated. Such embodiments include, without limitation, cord operated motors and battery operated motors. Examples of batteries for battery operated motors include, without limitation, rechargeable batteries and disposable batteries.

In another more detailed embodiment in accordance with the embodiment of the FIGURE, motor 120 is spring operated. In such embodiments, the wearer stores energy in apparatus 100 by first winding up motor 120.

In another more detailed embodiment in accordance with the embodiment of the FIGURE, apparatus 100 further comprises a clutch 150. In operation, clutch 150 limits the torque applied to earring back holder 130. Such torque limiting serves to prevent discomfort to the wearer resulting from otherwise excessive torque. Clutch 150 denotes any apparatus capable of performing the indicated function including, without limitation, clutches employing friction, magnetic, or fluidic coupling means.

In another more detailed embodiment in accordance with the embodiment of the FIGURE, motor 120 is reversible. In such embodiments, apparatus 100 is used for removing (unfastening) as well as fastening earring 110.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for fastening an earring, said apparatus comprising:
a motor adapted for generating a torque; and
an earring back holder adapted for applying said torque to an earring back.

2. The apparatus of claim 1 wherein said earring back holder is removable.

3. The apparatus of claim 1 wherein said earring back holder is magnetized.

4. The apparatus of claim 1 wherein said motor is electrically operated.

5. The apparatus of claim 1 wherein said motor is spring operated.

6. The apparatus of claim 1 further comprising a clutch adapted for limiting said torque.

7. The apparatus of claim 1 wherein said motor is reversible.

8. An apparatus for fastening an earring, said apparatus comprising:
a motor adapted for generating a torque; and
an earring back holder adapted for applying said torque to an earring back,
said earring back holder being removable,
said motor being electrically operated.

9. The apparatus of claim 8 wherein said earring back holder is magnetized.

10. The apparatus of claim 8 wherein said motor is spring operated.

11. The apparatus of claim 8 further comprising a clutch adapted for limiting said torque.

12. The apparatus of claim 8 wherein said motor is reversible.

13. A method for fastening an earring, said method comprising:
generating a torque using a motor; and
applying said torque to an earring back using an earring back holder.

14. The method of claim 13 wherein said earring back holder is removable.

15. The apparatus of claim 13 wherein said earring back holder is magnetized.

16. The method of claim 13 wherein said motor is electrically operated.

17. The method of claim 13 wherein said motor is spring operated.

18. The method of claim 13 further comprising limiting said torque using a clutch.

19. The method of claim 13 wherein said motor is reversible.
